(19) United States
(12) Patent Application Publication
(10) Pub. No.: US 2002/0029169 A1
(43) Pub. Date: Mar. 7, 2002

(54) Method and system for e-transaction

(76) Inventors: Katsuhiko Oki, Tokyo (JP); Koji Kishino, Tokyo (JP); Toshio Koro, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/754,710

(22) Filed: Jan. 11, 2001

(30) Foreign Application Priority Data
Sep. 5, 2000 (JP) 2000-269173

(51) Int. Cl. G06F 17/60; H04K 1/00; H04L 9/00

(52) U.S. Cl. 705/26; 705/5; 705/77; 705/78

(57) ABSTRACT

The present invention provides a method and system for purchasing and exchanging a ticket, coupon or similar item utilizing a wireless computer by a user.

A user who makes a purchase utilizing a wireless technique can receive information data recordable in a memory connected to an internal memory or a wireless computer. Such information data include a ticket, coupon or similar item.

Moreover, the information data can be transmitted to another person by a radio. In order to confirm contents of the ticket, coupon or similar item, the wireless computer, which receives or stores the ticket, coupon or similar item in a memory, can display the contents such as date, price and the other relating information on a screen.

### BACKGROUND OF THE INVENTION

1. Field of the Invention

This invention relates to a method and system for allowing a consumer to buy, if payment is necessary, obtain, transfer and use tickets, coupons or similar items.

2. Description of the Related Art

To date, when a consumer wished to buy a ticket to enter a certain place such as a theater or open place such as a highway it was necessary to buy a ticket which appeared on paper to allow the person entrance. The transaction for buying such ticket could be conducted in person at a ticket counter or agency handling ticketing such as a travel agency.

Alternatively the consumer could make a reservation by Internet and give their credit card number to order a ticket to be sent by mail or an e-ticket to issue.

When the ticket was sent by mail, the customer had to wait for the ticket to arrive, bring the ticket with them and depending on the ticket could have to buy a new one if they lost it.

In the event of buying an e-ticket for an airplane flight, carrying identification was sufficient to be allowed to enter a flight however, transferring such ticket to another would require making calls to the airline to change the name of the recipient and other resulting procedures.

### SUMMARY OF THE INVENTION

The present invention described herein overcomes the aforementioned problems.

A first objective of the present invention is to provide a method and system for consumers to be able to buy, if payment is necessary, obtain, transfer and use a ticket, coupon or similar item with a wireless computer.

A second objective of the present invention is to allow the consumers to transfer ticket, coupon or similar items, coupons and similar item from one to another. In order to confirm the contents of a ticket, coupon or similar item, a screen of a wireless computer can display information data related to such item that may include the time, date, place, price paid or other conditions related to the item. This transfer is carried out by sending information data from the receiving wireless computer and may include that the ticket, coupon or similar item be erased from the memory of the sending wireless computer so that any fear of the same ticket, coupon or similar item being given to two separate people at the same time can be alleviated.

The above-stated and other objectives and technical features of the present invention will become apparent from the following description when taken with the accompanying drawings.

It will be understood, however, that the drawings are for purposes of illustration and are not to be construed as defining the scope of an invention, reference being had for the latter purpose to the claims appended hereto.

### BRIEF DESCRIPTION OF THE DRAWINGS

FIG. 1 is a schematic diagram of a network showing one example of a schematic structure of an e-transaction system of the present invention.

FIG. 2 is a schematic diagram of a network showing one example of a schematic structure of the e-transaction system of the present invention.

FIG. 3 is a function block diagram showing one example of a wireless computer to be used in the e-transaction system of the present invention.

FIG. 4 is a schematic diagram of a network showing one example of a schematic structure of the e-transaction system of the present invention.

FIG. 5 is a schematic diagram of a network showing one example of a schematic structure of the e-transaction system of the present invention.

FIG. 6 is an explanatory diagram illustrating an information recording medium of the present invention.

### DESCRIPTION OF THE PREFERRED EMBODIMENTS

Hereinbelow, a detailed description will be given of preferred embodiments of the present invention with reference to the accompanying drawings.

(First Embodiment)

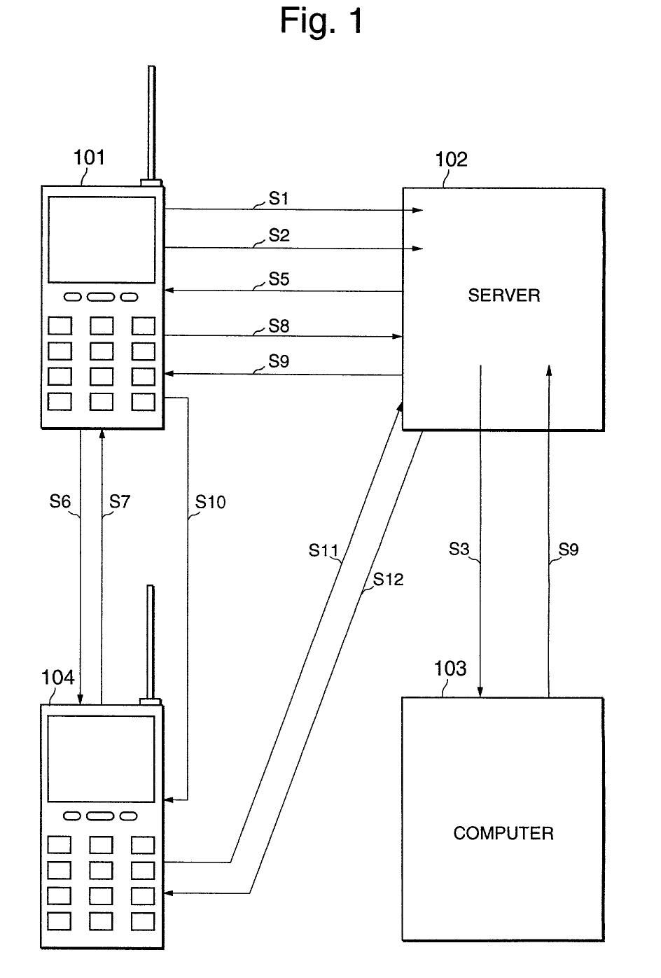

FIG. 1 shows wireless computer 101, a portable computing device such as a cell phone, palm computer, PDA or any computing device capable of wireless and wired communication is mobile or immobile, said wireless computer 101 having a memory accessible to wireless computer 101 that is physically non-removable or removable such as a floppy disk, memory stick or other such memory.

Server 102 is capable of wireless communication as well as wired communication and has a memory accessible to server 102 such as a database or other memory.

Server 102 could be a commercially available server or specially made server with wireless and wireless communication capabilities.

Computer 103 is a commercial computer capable of wired communication and having a memory accessible to said computer 103 such as a database or other memory.

Wireless computer 104 is a computer capable of wireless and wired communication comprising a cell phone, palm computer, personal digital assistant (PDA) or any computing device capable of wireless and wired communication is mobile or immobile, said wireless computer 104 having a memory accessible to wireless computer 104 that is physically non-removable or removable such as a floppy disk, memory stick or other such memory.

In step 1(S1) wireless computer 101 forms a communication link with server 102. Server 102 provides information in a format such as an Internet website to wireless computer 101 enabling searches and selections to be made of available tickets, coupons or similar items and related price information, if any, and further enabling input from wireless computer 101 to server 102.

In step 2(S2), a user of wireless computer 101 sends an information data to server 102 indicating an order for a ticket, coupon or similar item from server 102 further indicating a name for said user to be used in identifying their ownership of any ticket, coupon or similar item successfully acquired and including any required payment related information if so required.

Alternatively, in the event that said payment related information is required and is not provided simultaneously with said order, server 102 sends information data to wireless computer 101 indicating that payment related information is required.

Alternatively, in the event that no payment is required to receive said ticket, coupon or similar item, step 5(S5) is commenced next.

Once said required payment related information is received by server 102 in step 2, in step 3(S3) server 102 forms a communication link with computer 103. Server 102 communicates to computer 103 said required payment related information and said related price information of said order.

Computer 103 connects with said memory accessible to computer 103 and confirms said required payment related information and, if said required payment related information matches information contained in said memory accessible to computer 103 and that the account indicated by said payment information contains sufficient funds to pay said cost of said order, computer 103 records to said memory accessible to computer 103 a reduction in said account in the amount of said cost of said order and records credit equal to said cost of said order in an account for said server 102.

In step 4(S4) computer 103 sends a information data to server 102 indicating that payment has been completed for said order.

In the event that step 3 cannot be completed due to said required payment related information not matching said information contained in said memory accessible to computer 103, said account not having sufficient funds or other reason, in step 4, computer 103 sends information data to server 102 indicating that payment has not been completed.

Server 102 then returns to Step 2, by indicating to wireless computer 101 that said required payment related information was incorrect or that payment was unable to be processed and allowing wireless computer 101 to send new required payment related information.

Following completion of payment under step 4, in step 5 server 102 accesses said memory accessible to server 102 and records said name of said user as the owner of said ticket, coupon or similar item and sends a information data to wireless computer 101 that comprises a ticket, coupon or similar item.

Said ticket, coupon or similar item information data is able to be recorded in said memory accessible to wireless computer 101.

Said information data may be accessed from said memory accessible to wireless computer 101 and be displayed on a screen of wireless computer 101.

In step 6(S6), said user of computer 101 decides to deliver or transfer said ticket, coupon or similar item information data to a user of said wireless computer 104.

Said user of computer 101 may decide on their own, apart from this invention whether they wish to receive cash for the ticket, coupon or similar item, donate it free of charge or whatever reason for transferring the ticket, coupon or similar item and what payment means they wish to pursue. Wireless computer 104, by way of example only, may be a wireless computer at a movie theater that receives ticket, coupon or similar item transfers from customers at the entrance of a theater in exchange for allowing admission.

In step 6, wireless computer 101 forms a communication link with wireless computer 104, this communication link may be formed by means of wireless telephone making use of a wireless communication technology, said wireless communication technology may include Bluetooth or other wireless communication technologies.

Wireless computer 101 then sends said ticket, coupon or similar item to wireless computer 104 in the form of said ticket, coupon or similar item related information data.

Wireless computer 104 then accesses said memory accessible to wireless computer 104 and records said ticket, coupon or similar item related information data to said memory accessible to wireless computer 104.

At least a part of said ticket, coupon or similar item related information data can be recalled from memory and displayed on a screen of said wireless computer 104.

In step 7(S7), wireless computer 104 sends ownership related information data indicating to erase said ticket, coupon or similar item related information data from said memory accessible to wireless computer 101 and further indicating to wireless computer a name to send to said server 102 to record as a new owner of said ticket, coupon or similar item related information data to said memory accessible to server 102.

In step 8(S8), wireless computer 101 forms a communication link with server 102 and indicates to change said name of said ticket, coupon or similar item related information data recorded in said memory accessible to server 102 from said name to said new name.

Server 102 then accesses said memory accessible to server 102 and orders that said name of said ticket, coupon or similar item related information data be changed as recorded from said name to said new name.

Said erasure from said memory accessible to wireless computer of said ticket, coupon or similar item related information data either in step 7 or step 8.

Following said erasure, said ticket, coupon or similar item related information data can no longer be viewed on said screen of wireless computer 101.

Following completion of Step 8, in Step 9(S9), server 102 sends new ownership related information data to wireless computer 101 indicating said new name has been recorded.

Wireless computer 101 then erases from said memory accessible to wireless computer 101 said ticket, coupon or similar item related information data.

In step 10, wireless computer 101 sends new ownership completion related information data to wireless computer 104 indicating that said ticket, coupon or similar item related information data has been erased from said memory accessible to wireless computer 101 and further indicating that said new name has been recorded as the owner of said ticket, coupon or similar item related information data.

As an alternative to steps 8 and 9 and part of step 10(S10), in a separate embodiment of the present invention, said user of wireless computer 104 may in step 11 form a communication link with server 102 and send ownership change related information data ordering that said name be changed to said new name as said owner of said ticket, coupon or similar item related information data.

Server 102 then accesses said memory accessible to server 102 and orders that said name of said owner of said ticket, coupon or similar item related information data be changed from said name to said new name.

Following successful completion of step 11(S11), server 102 sends new ownership related information data to wireless computer 104 indicating said new name as being recorded as said owner of said ticket, coupon or similar item information data.

In this alternative embodiment, in steps 7 and 10, said user of wireless computer 104 may send erasure related information data to erase said ticket, coupon or similar item related information data from said memory accessible to wireless computer 101 and receive a information data from wireless computer 101 indicating completion of said erasure.

[Second Embodiment]

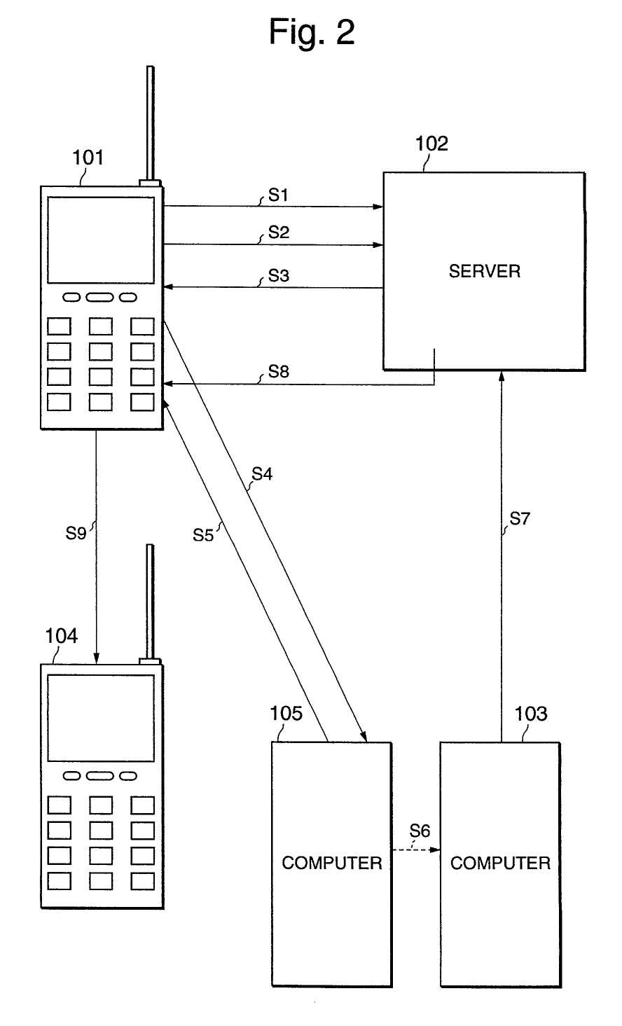

There will be explained below a second embodiment of the present invention with reference to FIG. 2. Here, the description relating to a substantially similar structure in the first embodiment is omitted, and only different portions will be explained.

FIG. 2 is a function block diagram schematically showing a structure of the e-transaction system of the present embodiment.

FIG. 2 shows wireless computer 101, server 102, computer 103, wireless computer 104 and computer 105.

FIG. 2 shows and alternative embodiment of the present invention to accommodate said user of wireless computer 101 if required payment related information data is required and should they wish to make payment by electronic wire transfer or by similar communication means from one bank, credit institution or similar funds source to another. Computer 105 is a computer capable of wireless communication and non-wireless communication and has a memory accessible to computer 105.

Unlike the embodiment described above as to FIG. 1, in Step 2, said user indicates that they desire to pay by a method such as electronic wire transfer or similar means. In response to that upon receipt of an order to pay from server 102, in step 4 wireless computer 101 forms a wireless communication link with computer 105.

Required payment related information data is then sent from wireless computer 101 to computer 105 indicating an order to pay to computer 103 and further providing required payment related information for computer 105 to make payment to computer 103. Computer 105 then accesses said memory accessible to said computer 105 and records said order to pay. In step 5, computer 105 sends payment ordered related information data to wireless computer 101 indicating that payment to computer 103 has been ordered.

In step 6, computer 105 forms a communication link with computer 103 and provides required payment related information data for computer 103 to register that payment will be or has been provided from computer 105. Computer 103 then accesses said memory accessible to computer 103 and records as much of said required payment related information data as is required to conclude payment from computer 105's administration to computer 103's administration.

Upon registration at computer 103 that payment will be made, in step 7, computer 103 forms a communication link with server 102 and as indicated in step 4 relating to FIG. 1, sends information data to server 102 indicating that payment has been completed.

In step 8, server 102 carries out step 5 relating to FIG. 1 though it is numbered as step 8 in FIG. 2.

Step 9 is the same as step 6 relating to FIG. 1 and steps 7(S7), 8(S8), 9(S9), 10(S10), 11(S11) and 12(S12) are the same as indicated relating to FIG. 1.

In this embodiment, the order of steps 5 and 6 may be reversed.

A consumer can obtain a ticket for an airplane flight, a movie, or any other kind of entry related event or access as well as gift certificates, coupons or similar transaction related issued or redeemable items.

Similar items that carry the right to access to or receive a discount for a place, receive a discount for or receive a good or a service, can be ordered, received and transferred according to the present invention as well.

[Third Embodiment]

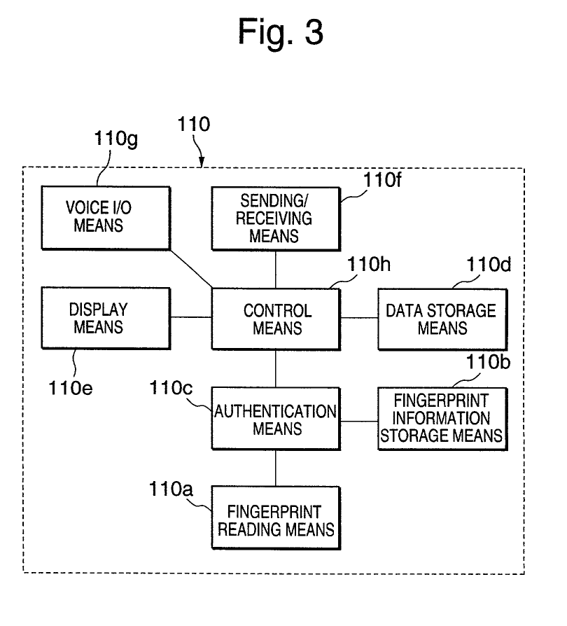

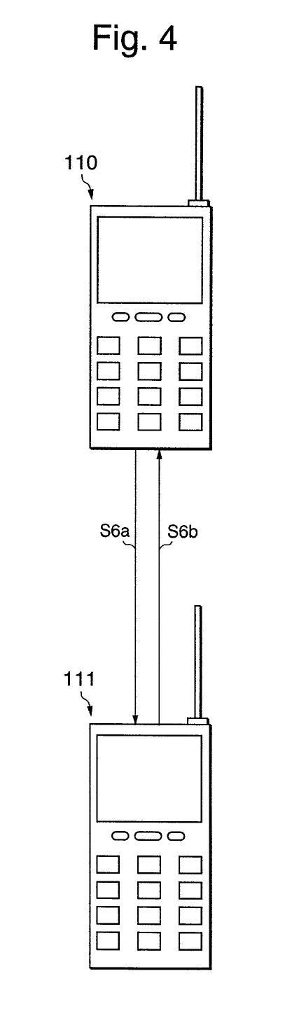

There will be explained below a third embodiment of the present invention with reference to FIGS. 3 and 4. Here, the description relating to a substantially similar structure in the first embodiment is omitted, and only different portions will be explained.

FIG. 3 is a function block diagram schematically showing a structure of a wireless computer to be used in the e-transaction system of the present embodiment.

This embodiment shows an example that an authentication function using fingerprint is provided to the abovementioned wireless computer.

As shown in FIG. 3, wireless computer 110 is constituted so as to include fingerprint reading means 110a, a fingerprint information storage means 110b, authentication means 110c, sending/receiving means 110f, voice I/O means 110g, display means 110e, data storage means 110d, operating means, not shown, and control means 110h.

Fingerprint reading means 110a reads fingerprint information of a user.

Fingerprint information of a user previously read and recorded is stored into fingerprint information storage means 110b.

Authentication means 110c collates the fingerprint information read by fingerprint reading means 110a with the fingerprint information stored in fingerprint information storage means 110b so as to authenticate the user.

Sending/receiving means 110f sends/receives data and signals to/from another information devices. Voice I/O means 110g inputs/outputs a voice through calling or the like.

Display means 110e displays data. The data displayed on display means 110e and another various data are stored in data storage means 110d. Operating means inputs operations. Control means 110h controls above-mentioned sections, and operates the respective sections only when authentication means 110c performs authentication properly.

FIG. 4 is an explanatory diagram for a case where the process for transferring a coupon or similar item similar to the above-mentioned first embodiment is performed between wireless computers 110 and 111 having such a fingerprint authentication function.

The structure and processes common to those in the first embodiment are omitted, and only different portions will be explained.

This embodiment exemplifies a case where fingerprint information of users are stored in wireless computers 110 and 111.

In this case, when wireless computers 110 and 111 are operated, authentication is performed respectively. For this reason, authentication time is short.

More concretely, in the above first embodiment, in step 6 when wireless computer 110 forms a communication link with wireless computer 111, the following steps are carried out.

Namely, in wireless computer 110, acknowledgement of performing fingerprint authentication is displayed and instructed on display means 110e.

When fingerprint reading means 110a reads a fingerprint of a user and authentication is performed properly, an acknowledge signal showing proper authenticated result is sent to wireless computer 111 (S6a).

In general, fingerprint authentication or the like is usually performed when a power is turned on in order to prevent improper use of wireless computer 110.

However, in this embodiment, exclusive commands or programs which start an authentication process when a ticket is transferred or the like is stored in data storage means 110d so that such fingerprint authentication can be used as authentication of a user when a power is turned on and also as authentication of a person who transfers a ticket or the like.

For this reason, authentication with high security can be performed without additionally using another exclusive encryption program or the like.

Further, when the acknowledge signal reaches wireless computer 111, wireless computer 111 instructs the user to perform fingerprint authentication via display means or the like.

When the authentication of the user is performed properly in wireless computer 111, an acknowledge signal showing that the authentication is performed properly is sent from wireless computer 111 to wireless computer 110 (S6b).

When authentication is not performed properly in either of wireless computers 110 and 111, the above-mentioned acknowledge signals are not output, and a communication link is not formed.

In such a manner, when the acknowledge signal reaches wireless computer 110, a communication link is established, and the process for transferring a ticket or the like is performed through the processes similar to those in the first embodiment.

This embodiment showed the example that authentication is performed when the transferring process is performed.

However, in the case where fingerprint authentication is performed when a ticket or the similar item is purchased, in step 2 of the first embodiment the above-mentioned similar authentication steps may be added.

Namely, a structure may be constituted so that the purchasing step is started with server 102 only when authentication is performed properly in wireless computer 110.

In addition, steps 6a and 6b may be carried out before the transferring process after the communication link is established.

According to this embodiment, the authentication function such as fingerprint authentication is provided to wireless computers so that the processes for purchasing and transferring a ticket or the like with high security can be performed.

Particularly when the transferring process is performed, information about a ticket or the like is deleted from one wireless computer and only the other wireless computer has ownership of a ticket or the like.

As a result, at a stage that display of a ticket or the like disappears on a transfer side, the ownership and ticket data are removed securely, and thus a situation that two users own one ticket or the like can be avoided by high security.

[Fourth Embodiment]

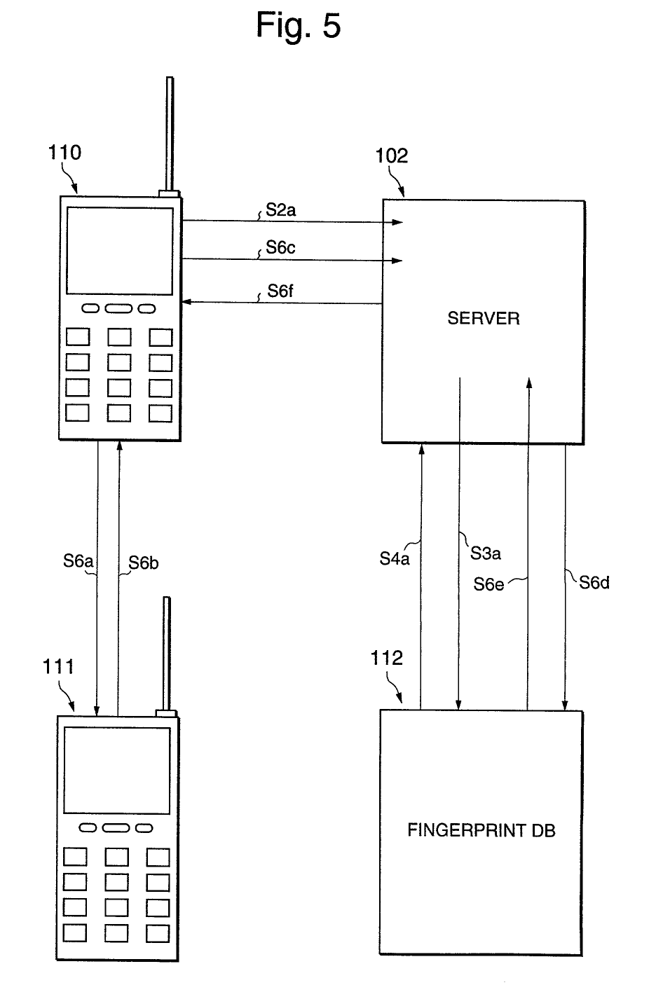

There will be explained below a fourth embodiment of the present invention with reference to FIG. 5.

Here, explanation relating to the structure substantially similar to that in the first embodiment is omitted, and only different portions will be explained.

FIG. 5 shows an example that wireless computers 110 and 111 have authentication function and fingerprint information is stored in a database and an authentication process is performed at server 102.

This system is provided with fingerprint database 112 in which fingerprint information of users is stored as well as wireless computers 110 and 111, in addition to sever 102, having fingerprint reading means.

In such a system, in order to perform fingerprint authentication in the transfer process of the first embodiment, in step 2 of the first embodiment, wireless computer 110 instructs a user to perform fingerprint authentication before sending, and the fingerprint information read by fingerprint reading means 110a is sent to server 102 (S2a).

Next, server 102 sends acknowledgment indicating that the fingerprint information is received by server 102 to fingerprint database 112, and fingerprint database 112 gives instruction in retrieving the fingerprint information of the corresponding user (S3a).

When the fingerprint information of the corresponding user is retrieved, fingerprint information of the user previously recorded is sent from fingerprint database 112 to server 112 (S4a). The fingerprint information read by server 102 and the fingerprint information in database are authenticated.

When a result of this authentication is proper, information indicating that the authentication is performed properly stands by in server 102.

Meanwhile, the authentication process in wireless computer 111 is instructed after or at timing with formation of the communication link in step 6 of the first embodiment (S6a). When a fingerprint is read, fingerprint information is sent from wireless computer 111 via wireless computer 110 to server 102 (S6b, S6c).

Thereafter, similarly to the authentication in wireless computer 110, retrieval (S6d), acknowledgment of retrieved result (S6e) and authentication process are performed.

When the authenticated result in wireless computer 110 matches with the authenticated result in wireless computer 111, server 102 sent a signal which shows that the transfer process may be performed to wireless computer 110 (S6f), and the transfer process similar to that in the first embodiment is performed.

According to this embodiment, database for fingerprint authentication is provided to server so that processes for purchasing and transferring of a ticket using fingerprint authentication can be performed in a stage of high security.

[Fifth Embodiment]

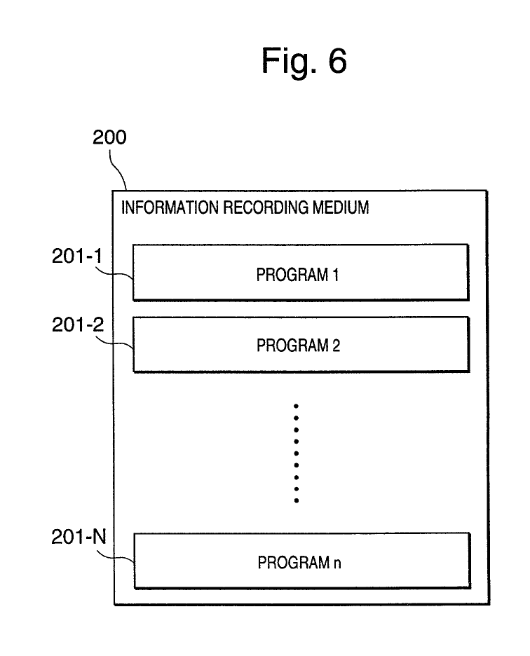

There will be explained below a fifth embodiment of the present invention with reference to FIG. 6.

This embodiment shows an example of an information recording medium in which programs processed by server in the system in the above-mentioned embodiments are recorded.

Such an information recording medium 200 comprises various media such as a hard disk, CDROM, DVDRAM, DVDROM, MO and ZIP.

Programs are recorded in this information recording medium 200. Such programs are used in e-transaction system for making e-transaction by means of a second device of a server or the like for providing services capable of obtaining a ticket, coupon or similar item using a first device composing a user computer or a wireless computer owned by a user.

This information recording medium 200 includes program information 201-1, program information 201-2 and program information 201-3.

The program information 201-1 forms a communication link between the first device and the second device.

The program information 201-2 orders and receives a ticket, coupon or similar item when information data are sent and received between the first device and the second device.

The program information 201-3 displays the ticket, coupon or similar item on a screen of the first device and obtains ownership of the ticket, coupon or similar item.

Further, the information recording medium 200 includes program information 201-4 and program information 201-5.

The program information 201-4 forms a communication link between the second device and a third device in the event that payment is required for transfer of the ticket, coupon or similar item, and sends second information data relating to an amount of deduct from an account of a user having the first device from the second device to the third device.

The program information 201-5 confirms the second information data at the third device and transacts payment by charging the account of the user the amount in the event that the account contains credit.

Further, the information recording medium 200 includes program information 201-6, program information 201-7 and program information 201-8.

The program information 201-6 sends third information data indicating whether payment was completed or not from the third device to the second device.

The program information 201-7 records a name of the user as a owner of the ticket, coupon or similar item in a second memory of the second device by means of the second device. The program information 201-8 sends fourth information data, including information identifying an account of a user having the first device and information about a name of the user and the ticket, coupon or similar item, from the second device to the first device.

Further, the information recording medium 200 includes program information 201-9 which reads a fingerprint of the user by means of the first device in the event that payment is required for transfer of the ticket, coupon or similar item and authenticates the user by means of the second device based on read fingerprint information.

Further, the information recording medium 200 includes program information 201-10 which reads a fingerprint of the user by means of the first device in the event that payment is required for transfer of the ticket, coupon or similar item, authenticates the user by means of the first device based on read fingerprint information and sends confirmation acknowledgment of an authenticated result to the second device.

Further, the information recording medium 200 includes program information 201-11 which sends new information for identifying an account of the user to the second device by means of the first device in the event that payment is required for transfer of the ticket, coupon or similar item and in the event that the third data indicates incompletion of the payment.

Further, the information recording medium 200 includes program information 201-12 and program information 201-13 and program information 201-14.

The program information 201-12 receives the fourth information data at the first device.

The program information 201-13 records the fourth information data in the first memory of the first device by means of the first device.

The program information 201-14 displays information including at least one portion of the fourth information data on the screen of the first device.

Further, the information recording medium 200 includes program information 201-15, program information 201-16 and program information 201-16.

The program information 201-15 forms a communication link between the first device and a fourth device owned by another user and sends the fourth information data from the first device to the fourth device. The program information 201-16 records the fourth information data in a fourth memory of the fourth device.

The program information 201-16 displays information including at least one portion of the fourth information data on a screen of the fourth device.

Further, the information recording medium 200 includes program information 201-17, program information 201-18 and program information 201-19.

The program information 201-17 authenticates a fingerprint of the user having the first device by means of the first device after or when the communication link is formed between the first device and the fourth device. The program information 201-18 authenticates a fingerprint of a user having the fourth device by means of the fourth device. The program information 201-19 instructs sending of the fourth information data in the event that the respective authentication is performed properly.

Further, the information recording medium 200 includes program information 201-20 and program information 201-21. The program information 201-20 sends fifth information data for instructing the fourth device to delete the fourth information data to the first device.

The program information 201-21 deletes the fourth information data from the first memory based on the fifth information data.

Further, the information recording medium 200 includes program information 201-22 and program information 201-23.

The program information 201-22 sends sixth information data including a second name of a user having the fourth device from the first device to the second device. The program information 201-23 instructs the second memory to change a name to be recorded as an owner of the ticket, coupon or similar item from a prior name into the new name based on the sixth information data.

Further, the information recording medium 200 includes program information 201-24 and program information 201-25.

The program information 201-24 sends seventh information data displaying that the fourth information data are deleted from the first memory from the first device to the fourth device.

The program information 201-25 displays information including the seventh information data on the screen of the fourth device.

Further, the information recording medium 200 includes program information 201-26, program information 201-27 and program information 201-28.

The program information 201-26 records a change in the name recorded as an owner of the ticket, coupon or similar item in a second memory of the second device.

The program information 201-27 sends eighth information data showing that the new name is recorded as the owner of the ticket, coupon or similar item from the first device to the fourth device.

The program information 201-28 displays information including the eighth information data on the screen of the fourth device.

In such a manner, the above-mentioned processes in the respective embodiments are recorded in information recording medium, and such an information recording medium can be distributed, copied or downloaded to be sold.

The apparatus and method of the present invention were explained according to some specified embodiments, but a person skilled in the art can variously modify the abovementioned embodiments in the present invention without departing from the gist and scope of the present invention. For example, the above-mentioned embodiments exemplified fingerprint authentication as the authentication method, but various authentication methods utilizing iris, voiceprint and the like or a combined method can be used.

Further, needless to say, the present invention includes examples that the above-mentioned embodiments are combined or one of the above embodiments is combined with one of modified examples.

What is claimed is:

1. A method for allowing consumers to obtain a ticket, coupon or similar item comprising:
forming a communication link between a first device and a second device and
sending and receiving information data between said first device and said second device
wherein said sending and receiving information data allows said first device to order and receive a ticket, coupon or similar item from said second device, said ticket, coupon or similar item being capable of display on a screen of said first device.

2. The method of claim 1 further comprising:
sending information data from said first device having access to a memory to said second device having access to a second memory;
forming a communication link between said second device and a third device having access to a third memory in the event that payment is required for transfer of said ticket, coupon or similar item;
sending from said second device to said third device a second information data comprising said information data and indicating an amount to deduct from said account in the event that payment is required for transfer of said ticket, coupon or similar item;
confirming said information data by third device accessing said third memory in the event that payment is required for transfer of said ticket, coupon or similar item;
transacting payment by charging said account of said user said amount in the event that said account contains adequate credit in the event that payment is required for transfer of said ticket, coupon or similar item;
sending a third information data from said third device to said second device indicating whether payment was completed or not in the event that payment is required for transfer of said ticket, coupon or similar item;
accessing said second memory by said second device;
recording said name of said user as a owner of said ticket, coupon or similar item in said second memory; and
sending a fourth information data from said second device to said device
wherein said information data comprises information identifying an account of a
user of said device for the purposes of making payment for said ticket, coupon or similar item in the event that payment is required for transfer of said ticket, coupon or similar item and, regardless of any payment requirement, further comprises a name for said user and said fourth information data comprising said ticket, coupon or similar item.

3. The method of claim 2 wherein in the event that payment is required for transfer of
said ticket, coupon or similar item and in the further event that said third information data indicates that payment was not completed:
allowing said first device to send to said second device new information identifying an account of said user; and
repeating all remaining parts of claim 2, in the event said new information is sent to said second device.

4. The method of claim 2 further comprising:
receiving said fourth information data at said first device;
accessing said memory by said first device;
recording said fourth information data to said memory by said first device; and
allowing display of information comprising at least a part of said fourth information data on a screen of said first device
wherein said user of said first device can display said fourth information data on said
screen of said first device upon accessing said fourth information data in said memory

5. The method of claim 4 wherein further comprising:
forming a communication link between said first device and said fourth device;
sending said fourth information data from said device to said fourth device; receiving said fourth information data at said fourth device;
accessing said fourth memory by said fourth device;
recording said fourth information data to said fourth memory; and
allowing said fourth device to display on a second screen information comprising at least a portion of said fourth information data.

6. The method of claim 5 wherein further comprising the steps of:
allowing said fourth device to send a fifth information data to said first device;
receiving said fifth information data at said first device, said fifth information data indicating that said fourth information data should be erased;
accessing said memory by said first device; and,
erasing from said memory said fourth information data in compliance with said fifth information data.

7. The method of claim 6 wherein further comprising:
sending as a part of said fifth information data a sixth information data;
forming a communication link between said first device and said second device;
relaying said sixth information data to said second device; and
recording by said second device to said second memory a change of names relating to said ticket, coupon or similar item from said name to said second name
wherein said sixth information data includes a second name for a user of said fourth
device and further indicates to said first device to communicate said sixth information data to said second device to indicate to change said name recorded as said owner of said ticket, coupon or similar item.

8. The method of claim 6 wherein following the completion of claim 6:
sending a seventh information data from said first device;
receiving said seventh information data at said fourth device; and
displaying on a screen of said fourth device information comprising said seventh information data
wherein said seventh information data indicates that said fourth information data has been erased from said memory.

9. The method of claim 6 wherein following the completion of claim 6:
forming a communication link between said fourth device and said first device;
accessing said second memory of second device;
recording to said second memory a change of information;
sending a eighth information data from said device;
receiving said eighth information data at said fourth device; and
displaying on a screen of said fourth device information comprising said eighth information data
wherein said change of information is a change of names recorded as the owner of said ticket, coupon or similar item and said eighth information data indicates that said second name was recorded as said owner of said ticket, coupon or similar item.

10. The method of claim 6 wherein further comprising:
forming a communication link between said first device and said fourth device using a wireless technology such as Bluetooth.

11. A e-transaction system for obtaining a ticket, coupon or similar item comprising:
a user computer with wireless communication capability;
a memory accessible to said user computer;
a server providing a website; and a second memory accessible to said server.

12. The e-transaction system of claim 11 further comprising a screen for display attached to said user computer whereby information data representing said ticket, coupon or similar item conveyed may be viewed when recalled from memory.

13. The e-transaction system of claim 12 wherein further comprising:
a second computer capable of communication; and
a third memory accessible to said second computer
wherein said server can form a communication link with said second computer, said
second computer can access said third memory and confirm any required payment related information data sent by said server and record changes in information data in said third memory relating to accounts recorded in said third memory.

14. The e-transaction system of claim 13 wherein further comprising:
a third computer capable of wireless communication;
a screen attached to said third computer; and
a fourth memory accessible by said third computer
wherein said third computer can send and receive information data to and from
said user computer, record information data representing a ticket, coupon or similar item and view said ticket, coupon or similar item upon accessing said fourth memory.

15. The e-transaction system of claim 14 wherein said third computer can communicate wirelessly with said server to order and confirm that said server recorded in said second memory information identifying a user of said third computer as the owner of a ticket, coupon or similar item previously owned by a user of said user computer.

16. The e-transaction system of claim 15 wherein said third computer may be used by an enterprise that makes use of tickets, coupons or similar items to conduct their business.

17. The e-transaction system of claim 14 wherein said third computer can communicate by wired means with said server to order and confirm that said server recorded in said second memory information identifying a user of said third computer as the owner of a ticket, coupon or similar item previously owned by a user of said user computer.

18. The e-transaction system of claim 17 wherein said third computer may be used by an enterprise that makes use of tickets, coupons or similar items to conduct their business.

19. The e-transaction system of claim 11, wherein said user computer includes:
fingerprint reading means for reading a fingerprint of the user;
authentication means for performing authentication based on information read by said fingerprint reading means and information previously recorded in fingerprint information storage means; and
data storage means for storing a program for instructing the authentication by means of said fingerprint reading means in the event that a ticket, coupon or similar item is purchased or transferred.

20. The e-transaction system of claim 14, wherein said third computer includes:
fingerprint reading means for reading a fingerprint of a user of said third computer;
authentication means for performing authentication based on information read by said fingerprint reading means and information previously recorded in fingerprint information storage means; and
data storage means for storing a program for instructing performing of the authentication by means of said fingerprint reading means in the event that a ticket, coupon or similar item is purchased or transferred.

21. The e-transaction system of claim 14, wherein:
said user computer includes:
fingerprint reading means for reading a fingerprint of the user;
authentication means for performing authentication based on information read by said fingerprint reading means and information previously recorded in fingerprint information storage means; and
first data storage means for storing a program for instructing the authentication by means of said fingerprint reading means in the event that a ticket, coupon or similar item is purchased or transferred,
said third computer includes:
fingerprint reading means for reading a fingerprint of a user of said third computer;
authentication means for performing authentication based on information read by said fingerprint reading means and information previously recorded in fingerprint information storage means; and
second data storage means for storing a program for instructing performing of the authentication by means of said fingerprint reading means in the event that a ticket, coupon or similar item is purchased or transferred,
one or both of said first data storage means and said second data storage means store(s) a program for sending and receiving data relating to purchasing and transfer between said user computer and said third computer in the event that the authentication is confirmed on said both means.

22. The e-transaction system of claim 11, wherein:
said user computer includes fingerprint reading means for reading a fingerprint of the user,
said server instructs said fingerprint reading means to perform authentication in the event that a ticket, coupon or similar item is purchased or transferred and performs the authentication based on information read by said fingerprint reading means and information previously recorded in fingerprint information storage means.

23. The e-transaction system of claim 14, wherein:
said third computer includes fingerprint reading means for reading a fingerprint of a user using said third computer,
said server instructs said fingerprint reading means to perform authentication in the event that a ticket, coupon or similar item is purchased or transferred and performs the authentication based on information read by said fingerprint reading means and information previously recorded in fingerprint information storage means.

24. The e-transaction system of claim 22, wherein said server starts to send and receive data relating to purchasing or transfer between said user computer and said server in the event that the authentication is confirmed.

25. The e-transaction system of claim 22, wherein said server starts to send and receive data relating to purchasing or transfer between said third computer and said server in the event that the authentication is confirmed.

26. An information recording medium for recording programs, to be used in an e-transaction system for making e-transaction by means of a second device for providing services capable of obtaining a ticket, coupon or similar item, using a first device owned by a user, said information recording medium comprising:
program information for forming a communication link between said first device and said second device;
program information for sending and receiving information data between said first device and said second device so as to order and receive a ticket, coupon or similar item; and
program information for displaying the ticket, coupon or similar item on a screen of said first device and obtaining a ownership of the ticket, coupon or similar item.

27. The information recording medium of claim 26, further comprising:
program information for forming a communication link between said second device and a third device in the even that payment is required for transfer of the ticket, coupon or similar item and sending second information data relating to an amount deduct from an account of the user having said first device from said second device to said third device;
program information for confirming the second information data at said third device and making payment by charging the account of the user the amount in the event that the account contains credit;
program information for sending third information data indicating whether the payment was completed or not from said third device to said second device;
program information for recording a name of the user as an owner of the ticket, coupon or similar item in a second memory of said second device by means of said second device; and
program information for sending fourth information data including information for recognizing the account of the user having said first device and information about the name of the user and the ticket, coupon or similar item from said second device to said first device.

28. The information recording medium of claim 27, further comprising program information for reading a fingerprint of the user by means of said first device in the event that payment is required for transfer of the ticket, coupon or similar item and authenticating the user by means of said second device based on read fingerprint information.

29. The information recording medium of claim 27, further comprising program information for reading a fingerprint of the user by means of said first device in the event that payment is required for transfer of the ticket, coupon or similar item and authenticating the user by means of said first device based on read fingerprint information and sending confirmed acknowledgment of the authenticated result to said second device.

30. The information recording medium of claim 27, further comprising program information for sending new information for recognizing an account of the user from said first device to said second device in the event that payment is required for transfer of the ticket, coupon or similar item and in the event that third information data indicates that payment was not completed.

31. The information recording medium of claim 27, further comprising:
program information for receiving the fourth information data at said first device;
program information for recording the fourth information data in the first memory of said first device by means of said first device; and
program information for displaying information including at least one portion of the fourth information data on the screen of said first device.

32. The information recording medium of claim 31, further comprising:
program information for forming a communication link between said first device and a fourth device owned by another user and sending the fourth information data from said first device to said fourth device;
program information for recording the fourth information data in a fourth memory of said fourth device; and
program information for displaying information including at least one portion of the fourth information data on a screen of said fourth device.

33. The information recording medium of claim 32, further comprising:
program information for authenticating a fingerprint of a user having said first device by means of said first device after or when a communication link is formed between said first device and said fourth device;
program information for authenticating a fingerprint of a user having said fourth device by means of said fourth device; and
program information for instructing sending of the fourth information data in the event that the respective authentication is performed properly.

34. The information recording medium of claim 32, further comprising:
program information for sending fifth information data for instructing said fourth device to delete the fourth information data to said first device; and
program information for deleting the fourth information data from said first memory based on the fifth information data.

35. The information recording medium of claim 34, further comprising:
program information for sending sixth information data including a second name of a user having said fourth device from said first device to said second device; and
program information for instructing said second memory to change a name to be recorded as an owner of the ticket, coupon or similar item from a prior name into a new name based on the sixth information data.

36. The information recording medium of claim 34, further comprising:
program information for sending seventh information data displaying that the fourth information data are deleted from said first memory from said first device to said fourth device; and
program information for displaying information including the seventh information data on the screen of said fourth device.

37. The information recording medium of claim 34, further comprising:
program information for recording change in the name recorded as the owner of the ticket, coupon or similar item in said second memory of said second device;
program information for sending eighth information data showing that the new name is recorded as the owner of the ticket, coupon or similar item from said first device to said fourth device; and
program information for displaying information including the eighth information data on the screen of said fourth device.
